(19) United States
(12) Patent Application Publication
(10) Pub. No.: US 2014/0058910 A1
(43) Pub. Date: Feb. 27, 2014

(54) METHOD FOR DETECTING IDENTITY MISREPRESENTATION IN FRAUDULENT TAX RETURNS

(71) Applicant: Gary E. Abeles, Verona, NJ (US)

(72) Inventor: Gary E. Abeles, Verona, NJ (US)

(21) Appl. No.: 13/971,142

(22) Filed: Aug. 20, 2013

Related U.S. Application Data
(60) Provisional application No. 61/691,290, filed on Aug. 21, 2012.

(51) Int. Cl. G06Q 50/26; G06Q 40/00

(52) U.S. Cl. CPC G06Q 50/265; G06Q 40/103
USPC 705/31

(57) ABSTRACT

A method for detecting identity theft and other fraudulent information in a tax return or other document requesting a refund or payment includes extracting key information from the document, comparing the key information with data obtained from a database, and flagging the document for further consideration if the document does not meet a minimum threshold of credibility. The key information can include a name, social security number, address, place of employment, wage data, and/or fraction of income withheld for taxes. The database can contain suspicious fact patterns of known fraudulent documents. A document can be flagged due to a single fact pattern comparison or due to a combination thereof, or due to a data contradiction. Databases can include IRS databases, other non-public governmental databases, public governmental databases, and non-governmental databases. Fraud can also be detected by tracking use of the refund or payment after it is issued.

### RELATED APPLICATIONS

This application claims the benefit of U.S. Provisional Application No. 61/691,290, filed Aug. 21, 2012, which is herein incorporated by reference in its entirety for all purposes.

### FIELD OF THE INVENTION

The invention relates to methods for preventing identity fraud, and more particularly, to methods for detecting fraudulent tax returns and other fraudulent documents associated with reimbursements or payments that are based on misrepresented identities or misrepresented status.

### BACKGROUND OF THE INVENTION

Tax fraud is a significant problem for nearly all taxing authorities. In particular, fraudulently filed tax returns based on fictitious or misrepresented identities and on other falsified data can lead to the issuing of illegitimate tax “refunds” that can be difficult to recover once the fraud has been uncovered.

For example, an unlicensed tax preparer used the pin number of his deceased boss to submit bogus tax returns claiming millions of phony tax refunds which were then deposited to his account.

Or identity thieves file false income tax returns and secure and cash large refunds. These tax returns are filed early in the filing season (January and February) before the IRS can stop the cashing of refund checks or prepaid debit cards, using fake W-2 data (sometimes from real employers) and claiming dependency exemptions for real people.

Currently, the IRS is encountering a massive problem with fraudulent tax returns based on identity theft and falsification other data. In the most recent two tax years, the IRS has paid out several hundred thousand erroneous and illegitimate tax refunds, amounting to billions of US dollars.

The problem is aggravated due to the following factors:
The IRS has been mandated by congress to increase compliance with electronic filing;
The IRS is under a mandate by congress to send all tax refunds to taxpayers within 45 days of receipt of tax return filings;
Upon request, payment of these refunds is made in the form of prepaid debit cards that can be difficult or impossible to trace afterward;
The offering for public sale by the Social Security Administration of information on almost 100 million deceased taxpayers has made identity theft of deceased persons much easier;
Widespread electronic availability of personal information has made identity theft of living persons much easier;
With the advent of social media, blogging, and social networking (Facebook, Twitter, etc), individuals are self-publishing personal information (names, addresses, dates of birth, etc) on the web, open for all to see;
The IRS is unable to cross-check wage information with other government agencies due to differences between the computer systems of the separate agencies; and
The IRS is unable to timely verify wage data submitted in tax returns.

In addition, identifying social security numbers (SSN's) is becoming relatively easy. Researchers at a major university were able to exploit public information to discover social security numbers. The first three digits of the SSN are issued according to the zip code of the mailing address provided on the application form. This is called the “area number”. The next two digits transition slowly and frequently remain constant over several years for a given area or region. These two digits are known as the “group number.” The final four digits are sequentially assigned.

For these reasons, SSNs assigned to applicants born in the same state on consecutive days most likely will contain the same first four or five digits, especially if the state is small and has a low population. It is especially easy to guess the first five digits of SSN's for people born after 1988, because since 1988 the Social Security Administration has tried to ensure that all newborns obtain social security numbers immediately.

Voter registration and commercial databases contain records of an individual's state and date of birth. Using the Social Security Death Master File, researchers were correctly able to identify on the first try 44% of the first five digits of the SSNs of deceased individuals born between 1973 and 1988.

Due to the way social security numbers are assigned, the last four digits are unique and can't be as easily guessed. Because of this, divulging this information puts the individual at high risk for identity theft. Nevertheless, the researchers mentioned above were able to identify all nine digits for people born after 1988 almost 10% of the time in fewer than 1,000 attempts. For individuals born in smaller states, all nine digits were identified in as few as 10 attempts.

Prior to the assignment of a preparer tax identification number (PTIN) by the Internal Revenue Service, the paid tax return preparer was required to disclose his social security number on the tax return. There are millions of these numbers on pages 1 or 2 of client tax returns routinely submitted by clients to banks, brokers, and other financial institutions.

In a recent case in NJ, an unlicensed tax preparer used the name, SSN, and PTIN of a deceased tax preparer to generate hundreds of thousands of dollars in phony tax refunds in the names of real clients of the deceased tax preparer.

In a typical scheme, a fraudulent tax return is filed electronically early in the tax season, for example in January or February, using the name and social security number of a dead person or of a real person who's personal information has been obtained by any of various means. The address on the tax return is not the real address of the individual whose identity has been stolen, and is typically a mail drop. The tax return includes a fictitious W-2 (which could be from a real company) and indicates a large amount of Federal withholding, so that a significant refund is due. The refund is processed by the IRS without verification, and sent to the mail drop. Typically, the refund is in the form of a prepaid debit card that, once issued, cannot be readily traced. Or the refund is made by direct deposit to a bank account or accounts that were opened based on the falsified and/or stolen identity, or that are otherwise controlled by the filer of the fraudulent tax return.

Only later is the information submitted in the tax return verified, using mainly or exclusively data that was not available at the time the refund was processed. By the time the fraud is discovered, the mail drop or bank account no longer exists and is not traceable to the perpetrator, so that recovery of the funds is difficult or impossible.

Similar problems exist in other contexts where fraudulent documents are associated with refunds or payments are based on identity or status misrepresentation. For example, the controller for a small Midwestern town was able to steal over $ 50 m over a 10-12 year period by setting up unauthorized bank accounts for the town, manipulating transfers, and forging documents to show that the monies were sent to the State.

In another case, a New Jersey couple scammed several million dollars from hundreds of customers by opening multiple corporations alleged to be travel agencies, stealing the deposits from customers for trips that were never booked, shuttering the corporation, and reopening for business under a brand new corporation with a different name. The process was repeated several times over a three year period. The couple was only caught because they waited around too long. If they had fled the state, they never would have been caught.

In yet another incident, New Jersey public workers collecting disability pensions were also working full-time jobs.

In another case, New Jersey public workers collecting pensions were incarcerated in Federal, New Jersey, county, or local jails and correctional institutions. Payments to these individuals were a violation of State statutes.

In still another case, a former Detroit Public Schools accountant and her daughter, a Detroit Public Schools teacher were recently convicted of fraud for setting up a sham company to purchase books for the school system, placing over $530,000 in orders thru this company, never ordering any books, and then pocketing all the money.

### Fraud in the Federally Funded National School Lunch Program (NSLP).

At a cost of over $8 billion annually, the program entitles over 30 million school children to free or reduced cost school breakfast and lunches. Participation in the program is the main criteria for a district to receive its allocation of Federal Title 1 funds. A higher percentage of eligible students also entitles the district to more funds from the Federal governments E-rate telecommunication program. In some states, school districts with higher percentages of NSLP participants also receive greater amounts of state aid for busing.

The more children participating, the more funds go to the district. This creates an atmosphere for fraud, since there is no incentive for a district to verify or weed out ineligible participants. Student eligibility in the program is determined using parents' income and household sizes based upon a poverty level formula determined annually by the Federal government. Children who live in certain residential poverty neighborhoods may automatically qualify for participation.

For the child to participate in the NSLP program, the parent or guardian fills out, signs and submits an application certifying that the income reported on the form is correct. A statement on the form warns that the signer might be subject to prosecution for giving false information on purpose. In contrast to other means-test Federal programs, no verification of income is required to be submitted.

The 2004 Congress amended the Richard B. Russell National School Lunch Program Act to require each school district to try and verify the income eligibility of the lesser of 3% or 3,000 of what are considered “error prone” participants, those that are within $100 of the monthly income eligibility limitation. To accomplish this, schools mail to the parent/guardian a request for verification of proof of income that was stipulated on the application. Failure to respond results in the student being terminated from the program. A response indicating that the income is too high will result in either a reduction in benefits or termination. A response indicating that income is too low may result in increased benefits.

A study done of the 10 largest US school districts for the 2007-2008 school year indicated that on average, benefits were reduced or terminated at a rate of over 70% (of the 3% tested), mostly due to the failure of the parent/guardian to respond to the inquiry. Studies of smaller school districts have shown similar termination rates.

A 2009 study published by Mathematica Policy Research found that 15% of students enrolled in the program received benefits that they were not eligible for. Mathematica estimated the program cost of allowing ineligible students to participate at over $1 billion annually.

### Fraud in State Administered Programs of Unemployment, Medicaid Assistance, and Pension Payments.

Recently a state audit covering July 2009 thru April 2011 disclosed that in NJ over $23 million in benefits was incorrectly paid to incarcerated felons in NJ prisons. Even though NJ statute indicates that unemployment benefits are for those that are able or available to work, more than $10 million in unemployment benefits were paid to prisoners. Additionally, over $7 million in state Medicaid payments were improperly paid to prisoners even though State statute prohibits such payments to prisoners. Several million dollars more in inappropriate State pension payments were made to prisoners even though statue prohibits this.

It is entirely plausible that the above situations are repetitive in many other states and are not isolated just in NJ.

What is needed, therefore, is a method for detecting identity theft and other fraudulent information in tax returns and other contexts, before payments are issued, without inhibiting the prompt issuing of legitimate payments (within 45 days for the IRS) and without limiting the methods used for such payments (including direct deposit and prepaid debit cards issued by the IRS).

### SUMMARY OF THE INVENTION

The present invention is a method for detecting identity theft and other fraudulent information in a tax return, or in another fraudulent document associated with a refund or payment. The method includes extracting from the document key information for credibility verification, and comparing the key information with a database of suspicious patterns of behavior known from previously discovered fraud, and/or with other databases that are available at the time of document submission. A credibility score is then determined from the comparison, and if the credibility score is above a specified minimum, the indicated refund or payment is issued according to established methods. If not, then the document is flagged for further verification, which in embodiments includes manual verification.

The key information can include the submitting individual's name, social security number (SSN), address, place of employment, wage data, and/or fraction of income withheld for taxes (if the document is a tax return).

Comparing the key information with other available data can include comparing the key data with suspicious fact patterns associated with previous fraudulent documents, and/or with information obtained from IRS databases, from other non-public governmental databases, from public governmental databases, and from non-governmental databases.

In some embodiments, the credibility score is assigned according to how closely the key data corresponds with suspicious fact patterns associated with previous fraudulent documents. In other embodiments, the document is flagged if there is a contradiction between the key data and other available data.

Note that the problem to be solved, and the solution offered by the present invention, are sometimes described herein with reference to the Internal Revenue Service (IRS) of the US federal government. However, it will be understood that the invention with suitable adjustments can also be applied to other taxing authorities and/or disbursing agencies, both in the US and in other countries, as well as other types of documents associated with refunds or payments.

The present invention is a method for a disbursing entity to determine if a document that appears to justify a refund or payment should be reviewed for possible fraud, the document being filed on behalf of an alleged recipient. The method includes extracting key information from the document, comparing the key information with information derived from a reference database, determining a credibility score from the comparison, if the credibility score is above a specified minimum, processing the refund or payment according to an established method, and if the credibility score is not above the specified minimum, submitting the document for additional verification.

In embodiments, the reference database is a database of suspicious fact patterns associated with previously discovered fraudulent documents.

In various embodiments, for at least one of the suspicious fact patterns the credibility score is determined to be below the specified minimum. In some of these embodiments, for at least one of the suspicious fact patterns, the credibility score is reduced by an amount that, in the absence of other reductions, does not lower the credibility score below the specified minimum. In other of these embodiments, the document is a tax return, and the suspicious fact patterns include claiming in the tax return of dependents having family names that differ from the family name of the alleged taxpayer.

In certain of these embodiments the document is a tax return, and the suspicious fact patterns include an income tax return filed with a form 1099-OID, indicating federal income tax withholding. In various of these embodiments, the suspicious fact patterns include a requested refund or payment that exceeds a specified amount. And in some of these embodiments the suspicious fact patterns include claiming a combination of alleged recipient age and dollar parameters of the document falls outside of a specified range of credible combinations.

In embodiments, the comparison with information derived from the reference database includes searching for data from the reference database that is contradictory with the key information. In various embodiments, the comparison includes at least one of translation or modification of data from the reference database, and translation or modification of data from the key information.

In certain embodiments, the comparison includes constructing a comparison database into which both the key information and data from the reference database can be imported. And in some of these embodiments the comparison database includes data fields with structures that are identical to structures of corresponding data fields in the reference database.

In some embodiments the document is a tax return that is requesting a tax refund. Some of these embodiments further include adjusting the credibility score according to a filing date of the tax return. In other of these embodiments the comparison with the reference database includes comparing the ratio of tax withheld divided by total income with an established range of such ratios that is considered typical.

In various embodiments the comparison with the reference database includes determining a consistency of the key data with at least one previous year document filed on behalf of the same alleged recipient. In certain embodiments the suspicious fact patterns include requests for a refund or payment that exceeds a refund or payment of the preceding year by more than a specified amount.

In some embodiments, at least one of extracting the key information, comparing the key information, and determining a credibility score is performed by a non-governmental entity that is distinct from the disbursing entity.

Various embodiments further include, if a refund or payment is issued by the disbursing entity as a prepaid debit card, monitoring usage of the prepaid debit card and comparing the usage with suspicious patterns of usage compiled in preceding years for suspect debit cards issued in response to documents that are suspected or known to be fraudulent. And some of these embodiments further include, if the usage of the prepaid debit card matches a pattern of usage of preceding year suspect debit cards, instructing a banking institution issuing the prepaid debit card to deny further use of the prepaid debit card pending further investigation.

And in certain embodiments fraud can be detected after a refund or payment is issued by monitoring usage of the refund or payment and comparing the usage with known suspicious usage patterns associated with other instances of known or suspected fraud.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a flow diagram illustrating the basic steps of the present invention.

### DETAILED DESCRIPTION

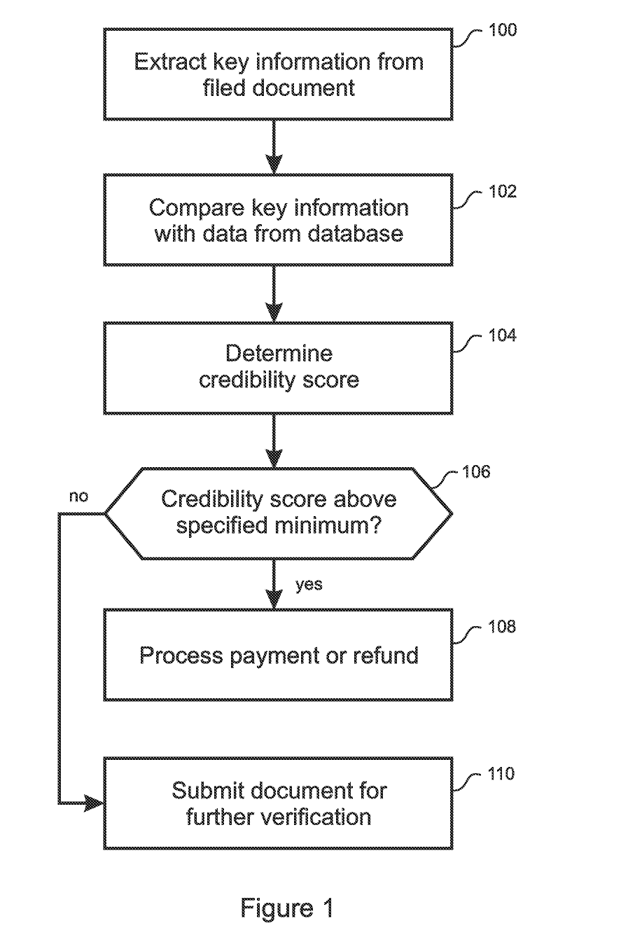

With reference to FIG. 1, the present invention is a method for detecting identity theft and other fraudulent information in a tax return, or in another fraudulent document associated with a refund or payment. The method includes extracting from the document key information for credibility verification 100, and comparing the key information with a database of suspicious patterns of behavior known from previously discovered fraud, and/or with other databases 102 that are available at the time of document submission. A credibility score is then determined 104 and compared with a specified minimum credibility score 106. And if the credibility score is above a specified minimum 108, the indicated refund or payment is issued according to established methods 110. If not, then the document is flagged for further verification 112, which in embodiments includes manual verification.

The key information can include the alleged recipient's name, social security number (SSN) and address, place of employment, wage data, and/or fraction of income withheld for taxes (if the document is a tax return).

Examples of correspondence between the key data and suspicious fact patterns associated with previous fraudulent documents

The submitter is identified by a social security number where identity theft has been utilized to obtain fraudulent tax refunds or other payments for the same social security number in prior years.

A tax return is filed within the first 6 weeks of the filing season.

The key information includes the employer's zip code and the filer's zip code, and the two are separated by more than a preselected mileage range.

There is a change of address compared to the prior year.

There is a change in W-2 employer from the prior year.

The document includes a request for a direct deposit to a bank account where other seemingly unrelated documents have requested direct deposits to the same account.

Dependents are listed on a tax return that were not claimed on a previous tax return.

W-2 forms submitted with a tax return contain Federal income tax withheld in amounts that are outside of normal parameters.

A tax return is self-prepared or is prepared by an unlicensed or unregulated preparer.

A tax return is electronically filed

The submitter requests prepaid, preloaded debit cards where a refund check or direct deposit of refund was issued prior years.

The submitter requests a direct deposit to a bank account different than a prior year.

A large payment or refund is requested where past filing years have requested small payments or have had balances due.

The IP address used to electronically submit the document is in a general business area that is different from the requestor's and/or outside of the US.

An income tax return is filed with form 1099-OID, indicating federal income tax withholding (in embodiments all such returns are flagged for manual review);

A document requests a refund or payment that exceeds a specified maximum threshold amount or that exceeds a refund or payment requested in the preceding tax year for the same submitter by a specified amount or specified percentage (in embodiments all such documents are flagged for manual review);

A tax return is filed early in the tax filing season, for example within the first 6 weeks of the filing season (noting that the majority of fraudulent tax returns are filed early in the tax filing season);

The document indicates a changes in income level, mailing address, and status as compared to a previous year document;

Income and withholding information included in a tax return falls outside of normal withholding parameters (for example $25,000 in Federal tax withheld out of $50,000 in total wages);

A tax return that claims dependents having different last names. In embodiments, the names of the dependents are then cross checked against other databases (such as social security administration).

A combination of submitter age and dollar parameters of the document falls outside of a specified range, for example if the SSN in a tax return indicates that the filer is 10 years old or 80 years old, but the document indicates an earned income of $1 million and $500,000 in withholding.

A comparison of databases from public information shows multiple corporations with same officers and addresses.

An employee of the same organization as the submitter, or of a related organization, who cooperates with the submitter to obtain or disburse funds has the same last name as the submitter, as determined for example, by a database check of state corporate records or a check of city payroll records.

For some of the examples of suspicious fact patterns given above, the credibility score of the document would be set below the minimum threshold if the document included the suspicious fact pattern, regardless of whether the document included any other contradictions or suspicious fact patterns. Other examples given above would lower the credibility score somewhat, but not necessarily below the minimum threshold, unless the document included further contradictions or further suspicious fact patterns.

### EXAMPLES OF COMPARING THE KEY DATA WITH DATABASES TO FIND CONTRADICTIONS

A database of disability pensioners is compared with the state's own database of income tax returns filed and state Department of Labor filings.

Databases of pension recipients are compared with databases listing prison inmates.

With reference to the specific example of fraud perpetrated on the National School Lunch Program (“NSLP”) discussed in the Background section above, the database of participants in the NSLP can be cross checked against a database of participants in other means-tested programs such as food stamps and temporary assistance to the needy. Participants that are also participants in other means-tested programs can be eliminated from further testing to satisfy the USDA.

The remaining participants in the NSLP can be cross checked with databases of income reported on current year and/or prior year filed Federal and/or State income tax returns. In some of these embodiments, a transcript is requested from the appropriate government agency so that it is not necessary to review a copy of the tax return itself. This approach is similar to the Federal requirement on a mortgage application where the borrower consents to income verification via an IRS transcript.

Those applications that fall outside of the income parameters for the program can then be identified and flagged and a detailed report of those flagged applications can be presented to the district for further review and action.

This system would instantaneously identify improper payments and send an electronic message to the paying agency to stop the payments pending further review of the case.

With reference to the improper payments of benefits to incarcerated felons discussed in the Background section above, a database of inmates can be compared with a database of individuals about to receive benefit payments, for example unemployment benefits. Those individuals listed in both databases would be flagged as ineligible to receive benefits, and the payments would be stopped. Key data used for this comparison can be based in the Social Security number of the individual soliciting the benefit payment. The database of inmates would typically be updated periodically as new inmates come in and other inmates finish their prison sentences.

Comparing the key information with data obtained from at least one database can also include one or more of the following:

### IRS Databases

Comparing the key information with a database of prior year document submissions, including personal information, mailing address, employment, income level, filing status.

Cross checking IRS databases and/or other databases to identify multiple refunds or payments and/or multiple alleged recipients using the same personal information and/or mailing address.

Cross checking IRS databases and/or other databases to identify multiple alleged recipients requesting direct deposit to the same bank account.

Comparing personal and employment information provided with the document with current employer payroll information contained in IRS and State databases.

Comparing personal and employment information provided with the document with a database of personal and employment information, including names, SSN's, mailing addresses, and employer names, used in prior year fraudulent tax returns.

Comparing personal and employment information provided with the document with information on Federal employer identification numbers on file in the IRS databases.

Comparing the filing date of the document with a database of filing dates in preceding years for the same alleged recipient, and flagging any documents that are filed significantly before the typical filing date for that alleged recipient, as established by a pattern of filing dates recorded in an annually updated document filing date database.

In cases where a direct deposit refund or payment is requested, comparing the direct deposit bank information submitted in the return with direct deposit banking information provided by the same alleged recipient in preceding submitted documents, and with a database of direct deposit information used in preceding years in submitted documents that are suspected or known to be fraudulent.

### Other Non-Public Government Databases

Comparing employment information provided with the submitted document with current and prior year individual and employer information contained in the Social Security Administration database, including birth and death information.

Cross checking the name, social security number, address, and/or W-2 employer info provided with the submitted document with other Federal and/or State databases, including but not limited to Social Security Administration, State Labor, and Taxation Departments.

Comparing a social security number provided with the submitted document with a list of social security numbers that have been associated with fraudulent tax returns or other fraudulent documents in the past.

Comparing the key information with information available at State banking regulatory agencies.

Comparing the key information with information available thru State motor vehicle agencies.

Comparing the key information with information available on voting records.

Crosschecking the key information regarding the alleged recipient's identity with the Social Security Master Death File.

### Public Government Databases

Comparing the key information with federal and State prison system databases.

Comparing the key information with records in the public domain at the local, county, or state level.

Comparing the key information with marriage records.

Comparing the key information with death records such as from probate courts or surrogate courts.

Comparing employment information provided with the submitted document with information on business formations, registrations, and licensing from public records on file with state agencies.

### Non-Governmental Databases

Comparing the key information with published death notices (both online and in print).

Comparing the key information with information obtainable thru credit bureaus.

Comparing the key information with information obtainable thru the court system.

Comparing the key information with information pertaining to real estate ownership, acquisitions, and sales.

In embodiments, the extracting of the key information and/or the comparison with at least one database is performed by an outside non-governmental contractor under agreement with the disbursing entity. In some cases, such non-governmental contractors may have greater expertise and/or fewer legal restrictions regarding access to third party databases and comparison with key data from submitted documents.

### Methods for Implementation of the Invention in Embodiments

In embodiments, the first step in implementing the present invention is to review the problem with the disbursing agency, review the current method of auditing and detection (if any), and determine the best course of resolution. Disbursing agencies typically do not retain forensic accountants on staff and do not have the resources or knowledge to detect and correct the problems.

The next step in embodiments is to formulate a program to select data from diverse databases or other sources and set up a system to identify or flag documents for activity that falls outside of a normal set of parameters which would be determined by the disbursing agency.

Comparisons between databases can be difficult, due to different database structures and different practices in populating the databases. Databases and the software and programs which run the databases are customized and unique for each system. It can therefore be difficult to compare and extract data from otherwise unrelated databases.

In some embodiments, when comparing data from two different databases of interest, appropriate data fields of interest in each of the databases are identified, and a new comparison database is designed and constructed. The fields in the comparison database are designed such that the data from the two databases of interest can be transferred thereto, possibly with some modification or translation. The data is then extracted from the fields of interest in the databases of interest and used to populate the data fields in the comparison database. Comparison of the data is then straightforward, since the data from both of the databases of interest are located in identical data fields and are no longer dissimilar.

In other embodiments, one of the two data bases of interest is selected and duplicated. The data from the data fields of interest from both of the databases of interest is then copied into the duplicate database, possibly with data from one of the databases of interest being translated or modified. Once again, comparison of the data is then straightforward, since the data from both of the databases of interest are located in identical data fields and are no longer dissimilar.

In still other embodiments, a database used by the disbursing agency is duplicated and populated with data extracted from the two databases of interest, possibly with some modification or translation. Once again, comparison of the data is then straightforward, since the data from both of the databases of interest are located in identical data fields and are no longer dissimilar.

In various embodiments, disbursements can be flagged for further review even after they are paid. For example, if a refund is issued in the form of a prepaid debit card for an early filed tax return, usage of the prepaid debit card can be monitored and compared with a database of suspicious usage patterns of prepaid debit cards issued in preceding years in response to tax returns that are suspected or known to be fraudulent. If the usage of the newly issued prepaid debit card matches a suspicious pattern of usage obtained from the database of previous year usage of suspect debit cards, the banking institution issuing the prepaid debit card can be instructed to halt usage of the prepaid debit card pending further investigation.

In embodiments, once fraudulent use of a payment or refund is identified, efforts can be made to identify and locate the perpetrator. For example, every computer that submits a tax return for electronic processing has its own unique IP address. The IP address can be traced to its origin and user. Prepaid debit cards can be traced and a trail of use established from the issuer of the card. Frequently these cards are utilized to purchase large ticket items (tvs, computers) that are purchased at big box stores and then sold on internet auction sites such as EBay. Each item (tv, computer, etc) contains a unique serial number that is on record with the big box retailer. The manufacturer can be contacted to obtain the identity of the warranty holder. That warranty holder (if not the perpetrator) can identify the auction site and seller. For fraudulent payments or refunds that are direct deposited into a bank account, the account can be analyzed and a trail of transfers/wires out traced.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A method for a disbursing entity to determine if a document that appears to justify a refund or payment should be reviewed for possible fraud, the document being filed on behalf of an alleged recipient, the method comprising:
extracting key information from the document;
comparing the key information with information derived from a reference database;
determining a credibility score from the comparison;
if the credibility score is above a specified minimum, processing the refund or payment according to an established method; and
if the credibility score is not above the specified minimum, submitting the document for additional verification.

2. The method of claim 1, wherein the reference database is a database of suspicious fact patterns associated with previously discovered fraudulent documents.

3. The method of claim 2, wherein for at least one of the suspicious fact patterns the credibility score is determined to be below the specified minimum.

4. The method of claim 2, wherein for at least one of the suspicious fact patterns, the credibility score is reduced by an amount that, in the absence of other reductions, does not lower the credibility score below the specified minimum.

5. The method of claim 2, wherein the document is a tax return, and the suspicious fact patterns include claiming in the tax return of dependents having family names that differ from the family name of the alleged taxpayer.

6. The method of claim 2, wherein the document is a tax return, and the suspicious fact patterns include an income tax return filed with a form 1099-OID, indicating federal income tax withholding.

7. The method of claim 2, wherein the suspicious fact patterns include a requested refund or payment that exceeds a specified amount.

8. The method of claim 2, wherein the suspicious fact patterns include claiming a combination of alleged recipient age and dollar parameters of the document falls outside of a specified range of credible combinations.

9. The method of claim 1, wherein the comparison with information derived from the reference database includes searching for data from the reference database that is contradictory with the key information.

10. The method of claim 1, wherein the comparison includes at least one of translation or modification of data from the reference database, and translation or modification of data from the key information.

11. The method of claim 1, wherein the comparison includes constructing a comparison database into which both the key information and data from the reference database can be imported.

12. The method of claim 11, wherein the comparison database includes data fields with structures that are identical to structures of corresponding data fields in the reference database.

13. The method of claim 1, wherein the document is a tax return that is requesting a tax refund.

14. The method of claim 13, further comprising adjusting the credibility score according to a filing date of the tax return.

15. The method of claim 13, wherein the comparison with the reference database includes comparing the ratio of tax withheld divided by total income with an established range of such ratios that is considered typical.

16. The method of claim 1, wherein the comparison with the reference database includes determining a consistency of the key data with at least one previous year document filed on behalf of the same alleged recipient.

17. The method of claim 1, wherein the suspicious fact patterns include requests for a refund or payment that exceeds a refund or payment of the preceding year by more than a specified amount.

18. The method of claim 1, wherein at least one of extracting the key information, comparing the key information, and determining a credibility score is performed by a non-governmental entity that is distinct from the disbursing entity.

19. The method of claim 1, further comprising, if a refund or payment is issued by the disbursing entity as a prepaid debit card, monitoring usage of the prepaid debit card and comparing the usage with suspicious patterns of usage compiled in preceding years for suspect debit cards issued in response to documents that are suspected or known to be fraudulent.

20. The method of claim 19, further comprising if the usage of the prepaid debit card matches a pattern of usage of preceding year suspect debit cards, instructing a banking institution issuing the prepaid debit card to deny further use of the prepaid debit card pending further investigation.

21. The method of claim 1, wherein fraud can be detected after a refund or payment is issued by monitoring usage of the refund or payment and comparing the usage with known suspicious usage patterns associated with other instances of known or suspected fraud.
